(19) United States
(12) Patent Application Publication
(10) Pub. No.: US 2013/0339284 A1
(43) Pub. Date: Dec. 19, 2013

(54) PREDICTED SOFTWARE USAGE DURATION

(71) Applicants: Noah Tilman Rowles, Pasadena, CA (US); Daniel Harlan Hawks, University City, MO (US)

(72) Inventors: Noah Tilman Rowles, Pasadena, CA (US); Daniel Harlan Hawks, University City, MO (US)

(73) Assignee: iolo technologies, LLC, Los Angeles, CA (US)

(21) Appl. No.: 13/524,294

(22) Filed: Jun. 15, 2012

(51) Int. Cl. G06N 5/02

(52) U.S. Cl. 706/46

(57) ABSTRACT

Techniques to predict software usage duration are disclosed. Software usage duration data indicating for each of a plurality of systems a duration of usage of an application or other software on that system is received. The software usage duration data is used to determine a predicted software usage duration for the application or other software.

### BACKGROUND OF THE INVENTION

Applications and other software may be installed on computing devices, such as servers, desktop computers, laptop or other mobile computers, mobile phones, or other devices that provide a processor configured to execute computer instructions, such as via an operating system or other runtime environment. Typically, data such as sales revenue and/or numbers of units sold, numbers of distinct installations, numbers of licenses activated, and/or numbers of online application purchases and/or downloads are used to measure the popularity of a software title and/or a version thereof. Customer surveys and/or software reviews written by experts or other users may be used to determine how widely used and/or well-received a particular software application is. The popularity of a software application may factor into such matters as a prospective user's decision whether to download, install, purchase a license, or otherwise obtain the application, advertising rates for ads displayed in connection with the application, and whether a particular application is effective, compatible, recommended or otherwise suggested for use on a particular system.

### BRIEF DESCRIPTION OF THE DRAWINGS

Various embodiments of the invention are disclosed in the following detailed description and the accompanying drawings.

FIG. 1 is a block diagram illustrating an embodiment of a system to predict software usage duration.

FIG. 2 is a block diagram illustrating an embodiment of a data structure to store client software usage data.

FIG. 3 is a block diagram illustrating an embodiment of a set of data structures to store software usage duration data.

FIG. 4 is a flow diagram illustrating an embodiment of a process to track and report software usage duration data.

FIG. 5 is a flow diagram illustrating an embodiment of a process to receive and store software usage duration data.

FIG. 6 is a flow diagram illustrating an embodiment of a process to compute and report statistics based on software usage duration data.

FIG. 7 is a flow diagram illustrating an embodiment of a process to recommend software applications to be installed or un-installed based on software usage duration data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to predict software usage duration are disclosed. In various embodiments, software installation and uninstallation times and/or dates are monitored, e.g., across multiple platforms and/or types of platform. A database of software usage duration, broken out in some embodiments by platform and/or environments within a type of platform, is created and maintained. Software usage duration data is compiled over time, and statistics are computed and used to predict how long a particular software application is expected to remain installed on, and presumably used at, a system on which it is or may become installed. In various embodiments, predicted software usage duration is used to recommend software to be installed at and/or removed from a system, to suggest an application and/or an advertising rate therefor to an advertiser, and/or to provide a rating or other score indicating a level of desirability, ongoing appeal, or sustained use of the software.

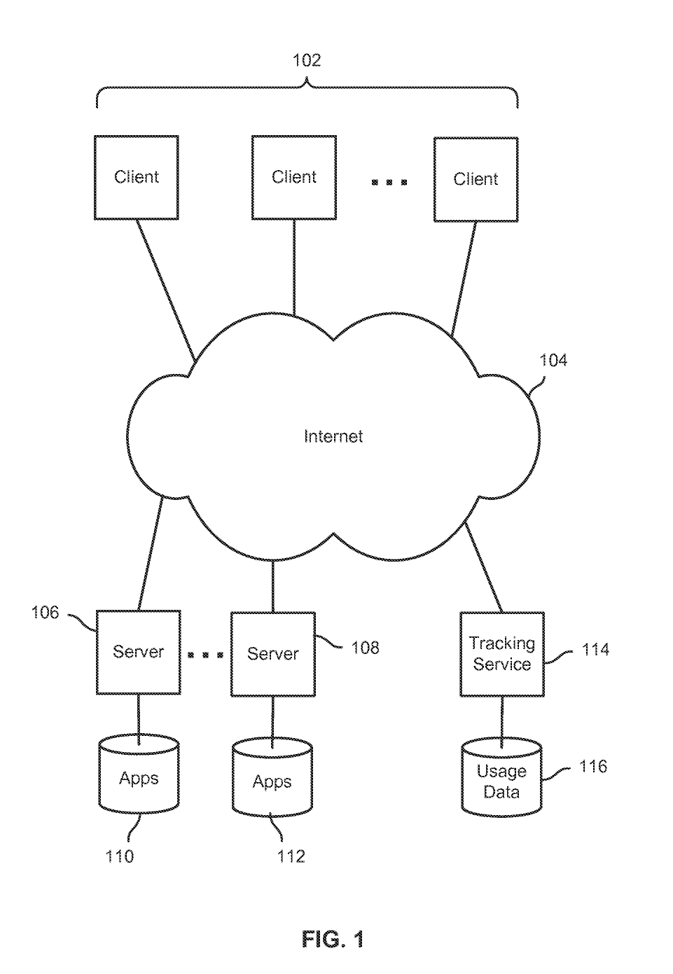

FIG. 1 is a block diagram illustrating an embodiment of a system to predict software usage duration. In the example shown, client (or other) systems represented by clients 102 use software applications, applets, utilities, tools, and/or other software installed at the client to perform tasks, such as productivity (e.g., word processing, spreadsheet), communication (e.g., email), entertainment (e.g., games), maintenance (e.g., utilities), or other tasks. Examples of clients 102 include, without limitation, desktop computers, laptop or other portable computers, tablet computers, and mobile “smart” phones or other mobile computing devices configured to run software such as applications. In the example shown, clients 102 are connected to the Internet 104. In some embodiments, one or more networks other than or in addition to the Internet provide connectivity, e.g., a corporate or other LAN/WAN. Applications that may be installed on clients 102 include applications available for download, for example after online purchase, via servers 106 and 108, which are configured to download software applications stored in application stores 110 and 112, respectively. A tracking service server 114 is connected to clients 102 via the Internet. In some embodiments, each client 102 has installed a utility or other software agent configured to monitor applications installed on the client. The agent on the client detects when a new application has been installed or uninstalled. In some embodiments, install and/or uninstall events, and/or other information reflecting the duration of software usage at the reporting client, are reported by the agent to the tracking service 114, which stores reported data in a software usage database 116. In some embodiments, a duration period is computed at the client and reported to the tracking service 114 upon uninstallation of a software application. The tracking service 114 compiles statistics, e.g., by client type and/or configuration (generally “platform”), and generates reports or other output reflecting software usage duration by platform (or in aggregate or otherwise).

In some embodiments, a mean duration of usage, median duration of usage, or other value considered to represent the typical case is computed for each platform and/or subcategory within a platform. In some embodiments, duration statistics are computed for application pairs, such as an average duration of usage of application A on platforms of type P when application B also is installed. In some embodiments, statistically relevant correlations are determined, and a predicted software usage duration is based at least in part on a statistically relevant correlation. For example, if within a platform P a very short duration of usage of application A is observed when application B also is present, as compared to the experience observed when application B is not present, than a prediction of a short duration of usage of application A in instances of platform P in which application B already is installed is made.

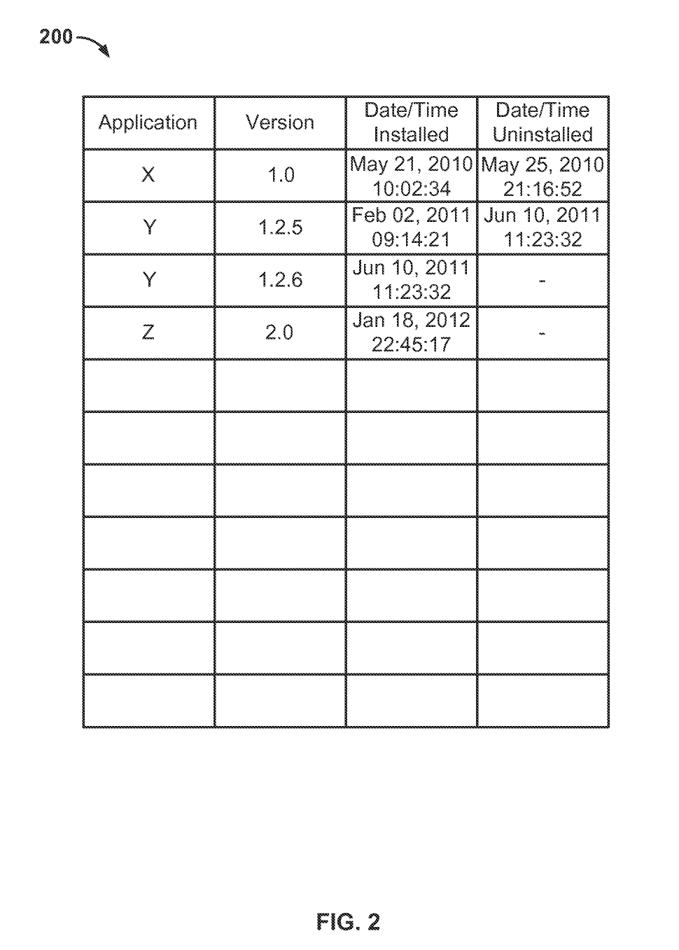

FIG. 2 is a block diagram illustrating an embodiment of a data structure to store client software usage data. In various embodiments, a data structure such as the one shown in FIG. 2 is stored on a client or other device or system to track applications installed on and uninstalled from the system. In the example shown, the data structure 200, such as a database or other table, includes a first (leftmost) column listing a name or other identifier for an application to which data in the corresponding row relates. The second (from the left) column lists a version number indicating a version of the software. The final two columns list the date/time installed and date/time uninstalled, respectively. In the example shown, applications X, Y, and Z are identified as having been installed at the dates/times indicated. Application X has been uninstalled, and a version 1.2.5 of application Y has been uninstalled in connection with an upgrade to version 1.2.6. In some embodiments, on or after uninstallation of application X and version 1.2.5 of application Y, an agent and/or other supervisory process on the client would have sent a report, e.g., to an application usage duration tracking service such as the service 114 shown in FIG. 1, of the duration of usage, e.g., the amount of time the application remained installed on the client, and related information such as an identification of the client and/or attributes of the client, such the operating system or other relevant environment in which the application was installed. In some embodiments, related information, such as concurrent installation of a subsequent version of the application, may be reported, to enable a distinction to be made between uninstallation events that may reflect a lack of interest in continuing to have and use an application, on the one hand, and a software upgrade to a newer version, on the other.

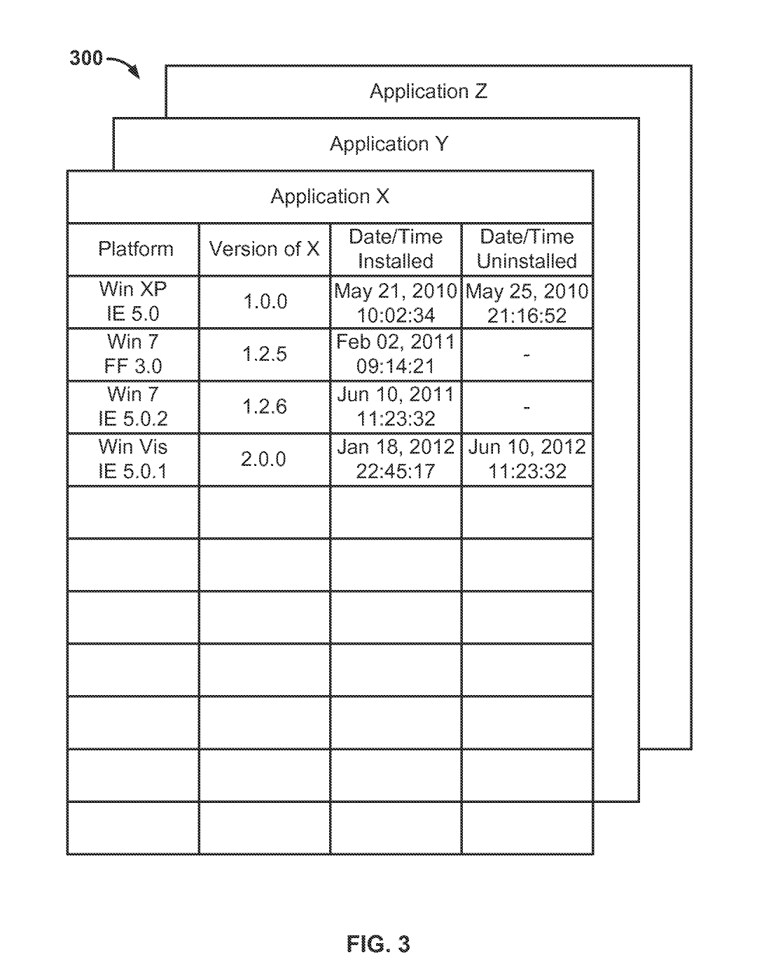

FIG. 3 is a block diagram illustrating an embodiment of a set of data structures to store software usage duration data. In various embodiments, a set of data structures such as those shown in FIG. 3 may be maintained at a central software usage duration tracking service, such as service 114 of FIG. 1. In the example shown, the data structures 300, e.g., database or other tables, include for each of a plurality of applications a table of data that includes for each of a plurality of clients a corresponding row indicating a client or other platform at which an instance of the application was installed, a version installed, a date/time of installation, and a date/time of uninstallation. In various embodiments, usage duration data such as that shown in FIG. 3 is used to compute for platform-application (and/or version) pairs a predicted software usage duration for each of the respective applications. In the example shown, data in the first row indicates the application X was uninstalled from a Windows XP™ system running Internet Explorer 5.0 as the web browser within a few days of being installed. If that pattern were observed having been repeated in other platforms with the same attributes, in some embodiments the tracking system would determine (predict) that other users with similar platforms would be likely to only use the application for a similar duration. More proactively, the system in some embodiments may recommend to users with client or other devices having the attributes of the first row of the example shown in FIG. 3 that they avoid installing the application X, or the version 1.0.0 thereof, for example because a significant percentage of other users with similar systems have chosen to uninstall it (for whatever reason) within a relatively short period of time.

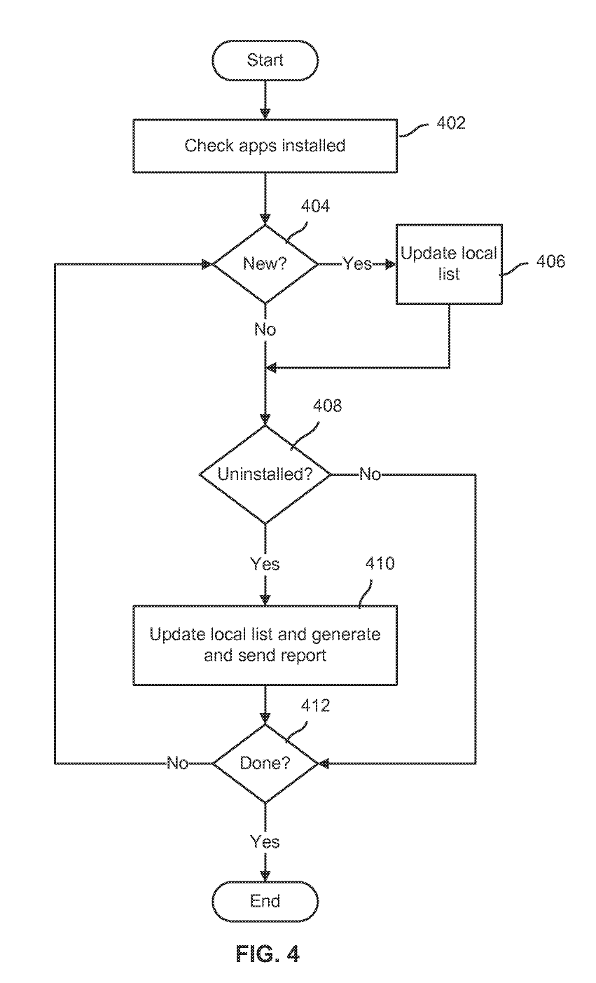

FIG. 4 is a flow diagram illustrating an embodiment of a process to track and report software usage duration data. In various embodiments, an agent or other supervisory process on a client system implements the process of FIG. 4. In the example shown, a check is performed to determine which applications (or other software) are installed on the device (402). If newly-installed applications are found to be present (404), they are added to a local list of installed applications (406), such as the one shown in FIG. 2. If applications are found to have been uninstalled (e.g., they are on the current list but not found to be present in the current check, performed periodically, in dynamic reaction to a predefined system event such as application install or uninstall, and/or at startup, for example) (408), the local list is updated and a report is sent to a remote service, such as the tracking service 114 of FIG. 1 (410), indicating in some embodiments the application, the date/time it was installed, the date/time it was uninstalled, and depending on the embodiment additional information such as an identification of the client and/or relevant attributes thereof. The process continues until done (412), for example the client system is shut down.

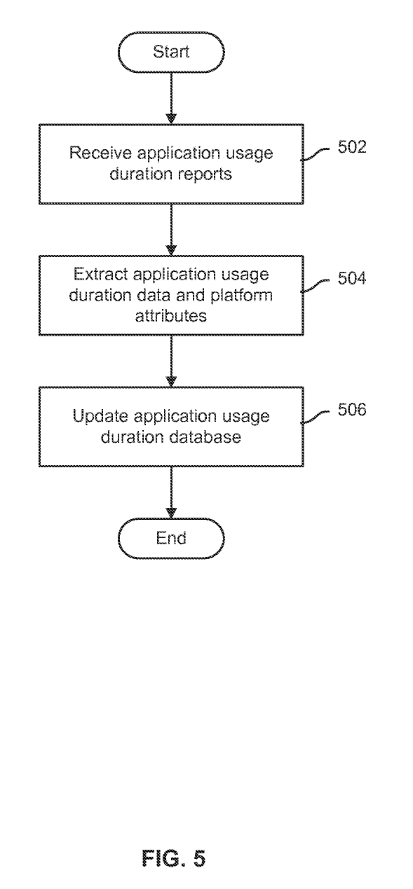

FIG. 5 is a flow diagram illustrating an embodiment of a process to receive and store software usage duration data. In various embodiments, the process of FIG. 5 is implemented by a software usage duration tracking service or other server. Application usage duration reports are received (502), for example from various reporting clients. Application usage duration data, e.g., application name or identifier, version, date/time installed, and date/time uninstalled, and platform attribute data regarding the client, are extracted from the received reports (504). For example, reports comprising structure or semi-structured data may be received and parsed programmatically to extract relevant usage duration data. The extracted data is used to update application usage duration statistics (506), for example by adding or updating rows in a database as shown in FIG. 3.

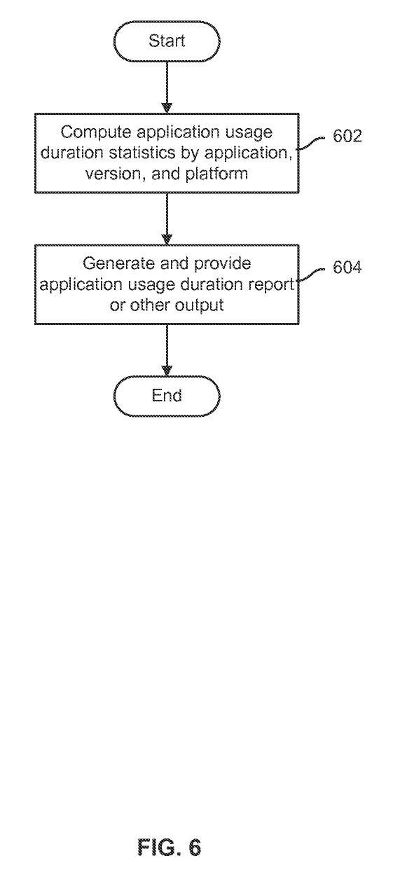

FIG. 6 is a flow diagram illustrating an embodiment of a process to compute and report statistics based on software usage duration data. In the example shown, application usage duration statistics are computed by application, version, and platform (602). For example, for a particular version of a particular application, in some embodiments a predicted duration is computed based on observed installation and uninstallation dates/times for clients of that type. In some embodiments, a distribution of probabilities is computed, for example, X % uninstall within a week, Y % keep it installed for at least a week but uninstall within three months, etc. A report comprising and/or based at least in part on the computed statistics is generated and provided as output (604). In some embodiments, the report is provided to application providers to enable them to identify problems and trends, compatibility issues, etc. In some embodiments, reports are provided to advertisers and/or related service providers, to enable them to determine the value and/or appropriate pricing to be paid for application related advertising and/or other opportunities. In some embodiments, a report is provided to enterprise IT personnel, for example to be used to determine whether enterprise users are using an application for long periods of time such that the license should be renewed.

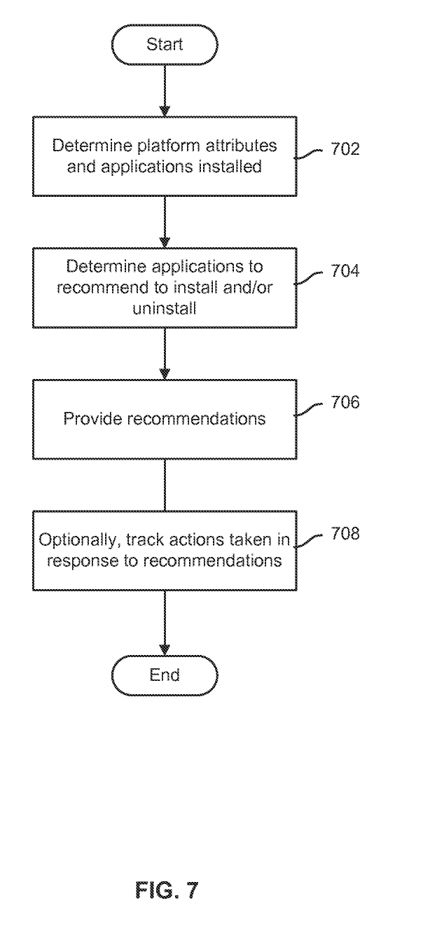

FIG. 7 is a flow diagram illustrating an embodiment of a process to recommend software applications to be installed or un-installed based on software usage duration data. In the example shown, attributes of a target platform and applications already installed thereon are determined (702). Applications to recommend to install and/or uninstall are determined (704). For example, based on attributes of the platform and other applications already installed thereon, an application that is predicted to have a long duration of usage on a platform of that type, or one of that type with certain other applications already installed, may be determined to be recommended. The recommendations are provided (706), for example via a graphical user or other interface. Optionally, actions taken by the user in response to a provided recommendation, e.g., whether the user accepted and acted on the recommendation, are tracked (708). In some embodiments, recommendations that are overwhelmingly not acted on are no longer (or are less likely) to be provided in the future to similar users.

While in various embodiments a duration of software usage is described as being determined based on install and uninstall dates/times, in other embodiments other measures of software usage are used, such as number of times and/or frequency with which the application is launched within a period, amount of time the user actively engaged with the application (e.g., in the active window) while launched, and/or other measures.

In some embodiments, predicted software usage duration is one factor that is combined with other information to compute a composite score for an application or application-platform pair. In some embodiments, pairs of potentially redundant applications are tracked, and a recommendation is provided based at least in part on whether other users who have had both applications installed concurrently have left them both installed for the relatively long term, or have instead mostly uninstalled one or the other of them within a relatively short time, and if so which one. In some embodiments, in making a recommendation other information about the client system user may be considered, for example whether the user has been observed to be a relatively active and/or well-informed participant in the management of the client system, as indicated for example by installing and properly configuring security and system utility software, actively installing and uninstalling applications, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving software usage duration data indicating for each of a plurality of systems a duration of usage of an application or other software on that system; and
using the software usage duration data to determine a predicted software usage duration for the application or other software.

2. The method of claim 1, wherein the software usage duration data indicates an amount of time that elapsed between installation and uninstallation of the application or other software at each system.

3. The method of claim 1, wherein determining a predicted software usage duration includes performing a statistical computation on at least a subset of the software usage duration data.

4. The method of claim 3, wherein the computation is performed using a subset of the software usage duration data and the subset includes data associated with systems that share a specified system attribute.

5. The method of claim 4, wherein the specified system attribute includes one or more of the following: a hardware attribute, a configuration data, an operating system, an installed application, and an application contemplated to be installed.

6. The method of claim 1, further comprising providing a recommendation to install the application or other software based at least in part on the predicted software usage duration.

7. The method of claim 1, further comprising providing a recommendation to uninstall or not install the application or other software based at least in part on the predicted software usage duration.

8. The method of claim 1, further comprising installing on each of at least a subset of systems comprising the plurality of systems a software agent configured to monitor and report one or both of application installation and application uninstallation events at the system.

9. A system, comprising:
a memory or other storage device configured to store software usage duration data, the software usage duration data indicating for each of a plurality of systems a duration of usage of an application or other software on that system; and
a processor coupled to the memory or other storage device and configured to use the actual software usage duration data to determine a predicted software usage duration for a client.

10. The system of claim 9, wherein the software usage duration data indicates an amount of time that elapsed between installation and uninstallation of the application or other software at each system.

11. The system of claim 9, wherein determining a predicted software usage duration includes performing a statistical computation on at least a subset of the software usage duration data.

12. The system of claim 9, wherein the processor is further configured to provide a recommendation to install the application or other software based at least in part on the predicted software usage duration.

13. The system of claim 9, wherein the processor is further configured to provide a recommendation to uninstall or not install the application or other software based at least in part on the predicted software usage duration.

14. The system of claim 9, wherein the processor is further configured to install on each of at least a subset of systems comprising the plurality of systems a software agent configured to monitor and report one or both of application installation and application uninstallation events at the system.

15. A computer program product embodied in a tangible, non-transitory computer readable storage medium and comprising computer instructions for:
receiving software usage duration data indicating for each of a plurality of systems a duration of usage of an application or other software on that system; and
using the software usage duration data to determine a predicted software usage duration for the application or other software.

16. The computer program product of claim 15, wherein the software usage duration data indicates an amount of time that elapsed between installation and uninstallation of the application or other software at each system.

17. The computer program product of claim 15, wherein determining a predicted software usage duration includes performing a statistical computation on at least a subset of the software usage duration data.

18. The computer program product of claim 15, further comprising computer instructions for providing a recommendation to install the application or other software based at least in part on the predicted software usage duration.

19. The computer program product of claim 15, further comprising computer instructions for is providing a recommendation to uninstall or not install the application or other software based at least in part on the predicted software usage duration.

20. The computer program product of claim 15, further comprising computer instructions for installing on each of at least a subset of systems comprising the plurality of systems a software agent configured to monitor and report one or both of application installation and application uninstallation events at the system.
